(19) United States
(12) Patent Application Publication
(10) Pub. No.: US 2026/0072880 A1
(43) Pub. Date: Mar. 12, 2026

(54) SYSTEM AND METHOD FOR PROVIDING AN OBJECT STORAGE BASED VOLUME SERVICE WITH SUPPORT FOR FILESYSTEM ACCESS

(71) Applicant: ORACLE INTERNATIONAL CORPORATION, Redwood Shores, CA (US)

(72) Inventors: Xiaoyu Yao, Seattle, WA (US); Bharat Viswanadham, Langley (CA); Shashikant Banerjee, Bengaluru (IN)

(21) Appl. No.: 19/098,742

(22) Filed: Apr. 2, 2025

(30) Foreign Application Priority Data
Sep. 6, 2024 (IN) 202441067498

(51) Int. Cl. G06F 16/182; G06F 16/16

(52) U.S. Cl. CPC G06F 16/183; G06F 16/162; G06F 16/166

(57) ABSTRACT

Embodiments described herein are generally related to cloud computing environments, such as cloud infrastructure or data analytics environments, and are particularly directed to systems and methods providing an object storage based volume service, with support for filesystem access. In accordance with an embodiment, filesystem access can be provided in accordance with Portable Operating System Interface (POSIX) standards, for storage and use of data within the cloud computing environment. The system can virtualize a hierarchical namespace for use with mounted filesystem paths on client machines, wherein paths to folders or individual files are mapped to immutable identifiers (IDs) are stored in a metadata layer as path-to-IDS mappings. Operations such as folder or file renames or deletes can be performed efficiently and independently of the folders/files below, by respectively updating a new name for an immutable ID, or by removing the immutable ID from the path-to-ID mapping.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CLAIM OF PRIORITY

This application claims the benefit of priority to India Provisional Patent Application titled “SYSTEM AND METHOD FOR USE WITH A DATA ANALYTICS ENVIRONMENT TO PROVIDE AN OBJECT-STORAGE BASED VOLUME SERVICE WITH POSIX SUPPORT”, application No. 202441067498, filed Sep. 6, 2024; which application and the contents thereof are herein incorporated by reference.

### TECHNICAL FIELD

Embodiments described herein are generally directed to systems and methods for providing an object storage based volume service, with support for filesystem access, for storage and use of data within a cloud computing environment such as a cloud infrastructure or data analytics environment.

### BACKGROUND

A cloud computing environment may include a data warehouse or other form of data storage or data repository that allows cloud customers to store and access their data, for subsequent use in generating data analytics, or for other purposes.

In some environments, the customer data can be stored as objects within an object storage resource. However, a typical object storage resource does not natively provide a folder-type data structure. As a workaround, customers who want to use object storage for their data may create objects and paths that mimic the use of folders, and use these objects to access their underlying data.

However, the use of such workarounds can lead to performance issues, particularly in connection with rename or delete operations. For example, a rename or delete operation can potentially trigger thousands of additional operations, because the object that is appearing to act as a parent “folder” is actually stored in object storage, which does not itself track folder relationships.

### SUMMARY

Embodiments described herein are generally related to cloud computing environments, such as cloud infrastructure or data analytics environments, and are particularly directed to systems and methods providing an object storage based volume service, with support for filesystem access.

In accordance with an embodiment, filesystem access can be provided in accordance with Portable Operating System Interface (POSIX) standards, for storage and use of data within the cloud computing environment. The system can virtualize a hierarchical namespace for use with mounted filesystem paths on client machines, wherein paths to folders or individual files are mapped to immutable identifiers (IDs) are stored in a metadata layer as path-to-IDS mappings. Operations such as folder or file renames or deletes can be performed efficiently and independently of the folders/files below, by respectively updating a new name for an immutable ID, or by removing the immutable ID from the path-to-ID mapping.

### BRIEF DESCRIPTION OF THE DRAWINGS

FIG. 1 illustrates a system for providing a cloud infrastructure or data analytics environment, in accordance with an embodiment.

FIG. 2 further illustrates how a cloud infrastructure or data analytics environment can be used to provide cloud-based applications or services, in accordance with an embodiment.

FIG. 3 illustrates an example cloud infrastructure architecture, in accordance with an embodiment.

FIG. 4 illustrates an example cloud infrastructure architecture, in accordance with an embodiment.

FIG. 5 illustrates an example cloud infrastructure architecture, in accordance with an embodiment.

FIG. 6 illustrates an example cloud infrastructure architecture, in accordance with an embodiment.

FIG. 7 illustrates how the system can be used to provide an object storage based volume service with support for filesystem access, in accordance with an embodiment.

FIG. 8 further illustrates use of an object storage based volume service with support for filesystem access, in accordance with an embodiment.

FIG. 9 further illustrates use of an object storage based volume service with support for filesystem access, in accordance with an embodiment.

FIG. 10 further illustrates use of an object storage based volume service with support for filesystem access, in accordance with an embodiment.

FIG. 11 further illustrates use of an object storage based volume service with support for filesystem access, in accordance with an embodiment.

FIG. 12 further illustrates use of an object storage based volume service with support for filesystem access, in accordance with an embodiment.

FIG. 13 further illustrates use of an object storage based volume service with support for filesystem access, in accordance with an embodiment.

FIG. 14 further illustrates use of an object storage based volume service with support for filesystem access, in accordance with an embodiment.

FIG. 15 further illustrates use of an object storage based volume service with support for filesystem access, in accordance with an embodiment.

FIG. 16 further illustrates use of an object storage based volume service with support for filesystem access, in accordance with an embodiment.

FIG. 17 further illustrates use of an object storage based volume service with support for filesystem access, in accordance with an embodiment.

FIG. 18 further illustrates use of an object storage based volume service with support for filesystem access, in accordance with an embodiment.

FIG. 19 further illustrates use of an object storage based volume service with support for filesystem access, in accordance with an embodiment.

FIG. 20 further illustrates use of an object storage based volume service with support for filesystem access, in accordance with an embodiment.

FIG. 21 further illustrates use of an object storage based volume service with support for filesystem access, in accordance with an embodiment.

FIG. 22 further illustrates use of an object storage based volume service with support for filesystem access, in accordance with an embodiment.

FIG. 23 illustrates a method for providing an object storage based volume service with support for filesystem access, in accordance with an embodiment.

### DETAILED DESCRIPTION

A cloud computing environment may include a data warehouse or other form of data storage or data repository that allows cloud customers to store and access their data, for subsequent use in generating data analytics, or for other purposes.

In some environments, the customer data can be stored as objects within an object storage resource. However, a typical object storage resource does not natively provide a folder-type data structure. As a workaround, customers who want to use object storage for their data may create objects and paths that mimic the use of folders, and use these objects to access their underlying data.

However, the use of such workarounds can lead to performance issues, particularly in connection with rename or delete operations. For example, a rename or delete operation can potentially trigger thousands of additional operations, because the object that is appearing to act as a parent “folder” is actually stored in object storage, which does not itself track folder relationships.

Embodiments described herein are generally related to cloud computing environments, such as cloud infrastructure or data analytics environments, and are particularly directed to systems and methods providing an object storage based volume service, with support for filesystem access.

In accordance with an embodiment, filesystem access can be provided in accordance with Portable Operating System Interface (POSIX) standards, for storage and use of data within the cloud computing environment. The system can virtualize a hierarchical namespace for use with mounted filesystem paths on client machines, wherein paths to folders or individual files are mapped to immutable identifiers (IDs) are stored in a metadata layer as path-to-IDS mappings. Operations such as folder or file renames or deletes can be performed efficiently and independently of the folders/files below, by respectively updating a new name for an immutable ID, or by removing the immutable ID from the path-to-ID mapping.

### Cloud Infrastructure Environments

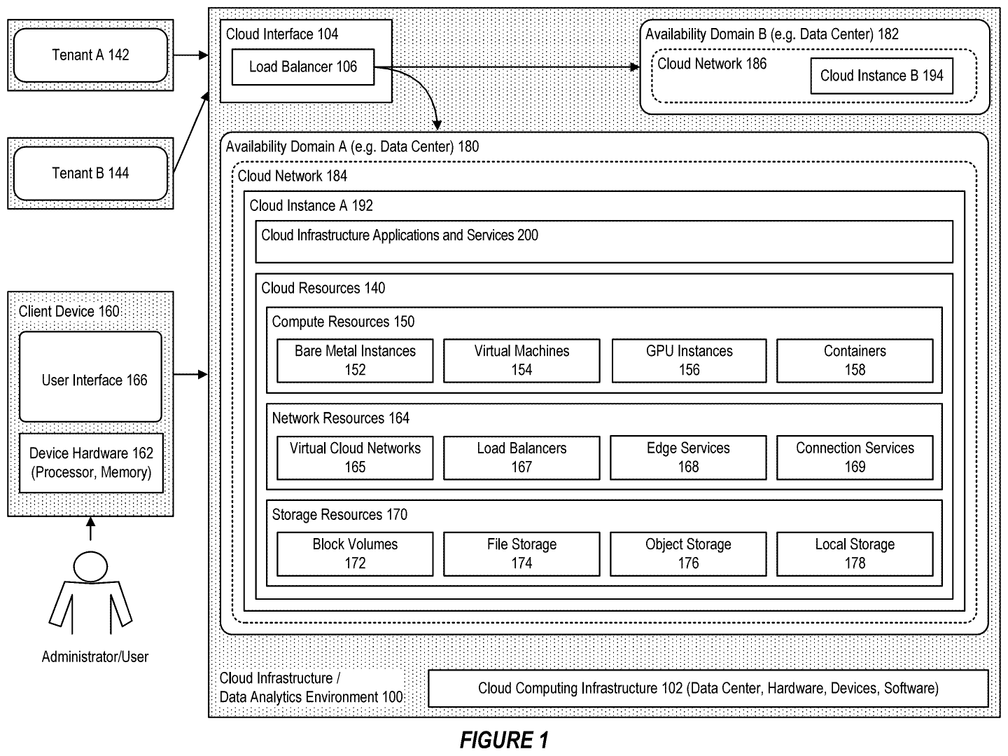

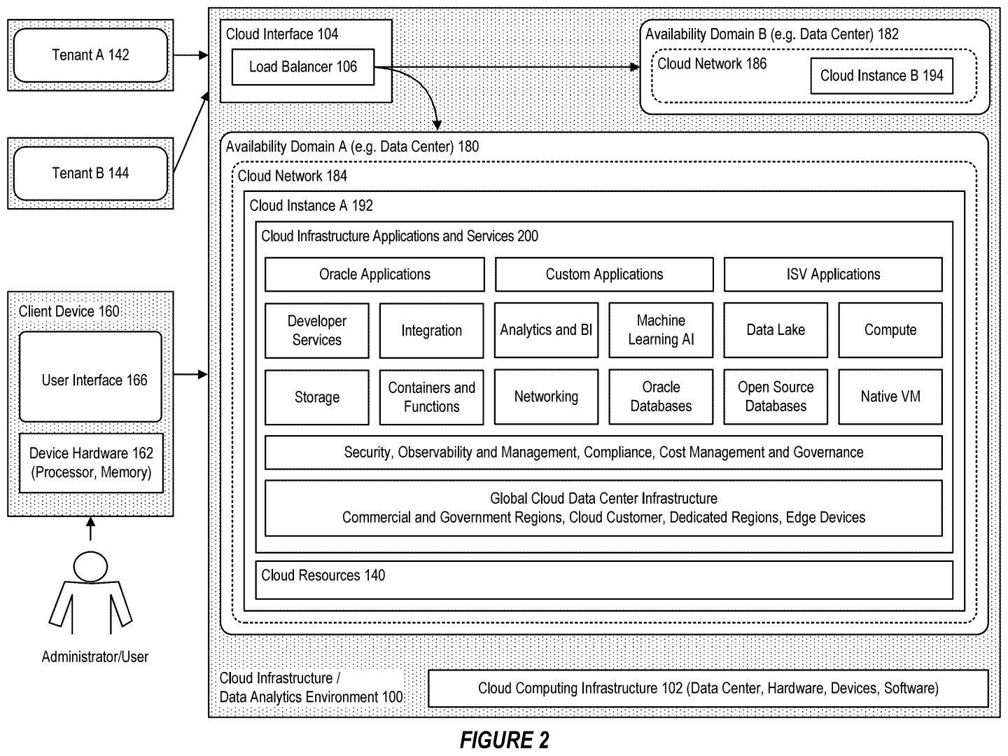

FIGS. 1-2 illustrate a system for providing a cloud infrastructure or data analytics environment, in accordance with an embodiment

In accordance with an embodiment, the components and processes illustrated in FIG. 1, and as further described herein with regard to various embodiments, can be provided as software or program code executable by a computer system or other type of processing device, for example a cloud computing system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers 106.

In accordance with an embodiment, the cloud infrastructure environment supports the use of availability domains, such as, for example, availability domains A 180, B 182, which enables customers to create and access cloud networks 184, 186, and run cloud instances A 192, B 194.

In accordance with an embodiment, a tenancy can be created for each cloud tenant/customer, for example tenant A 142, B 144, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 160 having a device hardware 162 (e.g., processor, memory), and graphical user interface 166, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 140 via, for example, a compute resources layer 150, a network resources layer 164, and/or a storage resources layer 170. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 152, virtual machines 154, graphical processing unit (GPU) compute cloud instances 156, and/or containers 158. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 165, load balancers 167, edge services 168, and/or connection services 169.

In accordance with an embodiment, the storage resources layer can comprise a number of resources, such as, for example, data/block volumes 172, file storage 174, object storage 176, and/or local storage 178.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 200, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

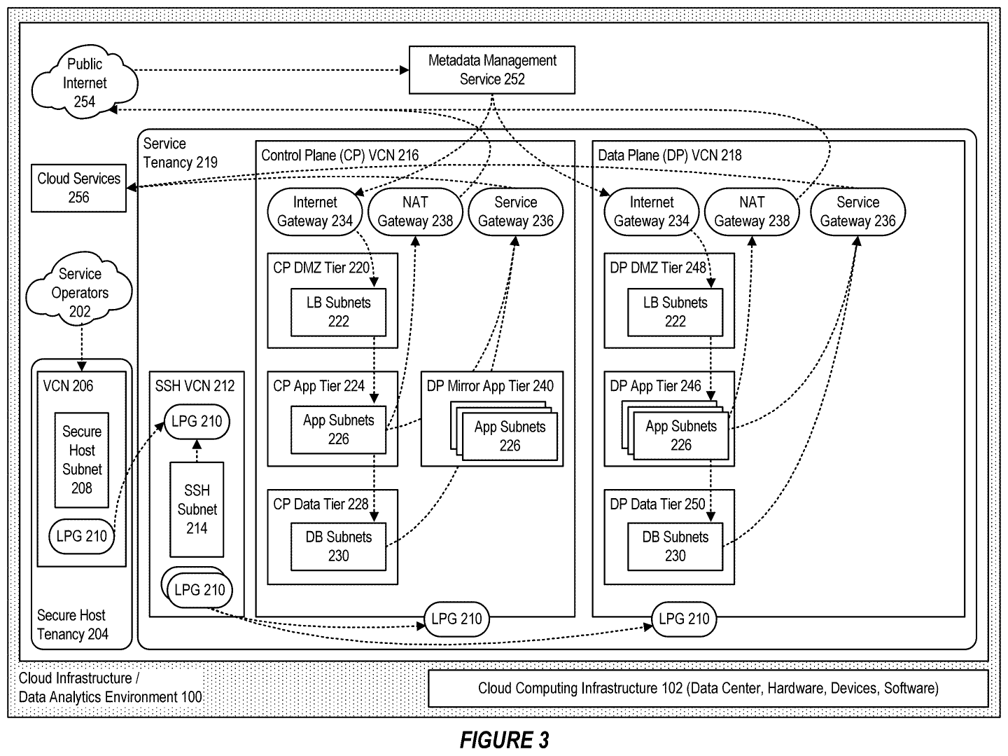

FIGS. 3-6 illustrate an example cloud infrastructure architecture, in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices, which may be portable handheld devices (e.g., a telephone, a computing tablet, a personal digital assistant (PDA)) or wearable devices (e.g., a head mounted display), running software such as Microsoft Windows, and/or a variety of mobile operating systems such as iOS, Android, and the like, and being Internet, e-mail, short message service (SMS), or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Chrome. Alternatively, or in addition, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnet(s) 222, a control plane app tier 224 that can include app subnet(s) 226, and a control plane data tier 228 that can include database (DB) subnet(s) 230 (e.g., frontend DB subnet(s) and/or backend DB subnet(s)). The LB subnet(s) contained in the control plane DMZ tier can be communicatively coupled to the app subnet(s) contained in the control plane app tier, and an Internet gateway 234 that can be contained in the control plane VCN, and the app subnet(s) can be communicatively coupled to the DB subnet(s) contained in the control plane data tier and a service gateway 236 and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier 246, a data plane DMZ tier 248, and a data plane data tier 250. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way: the service gateway can make API calls to cloud services, and cloud services can send requested data to the service gateway. Generally, cloud services may not initiate API calls to the service gateway.

In accordance with an embodiment, the secure host tenancy can be directly connected to the service tenancy, which may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example create, read, update, or delete (CRUD) operations, through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both of which may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage, which may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy, which may be isolated from the public Internet.

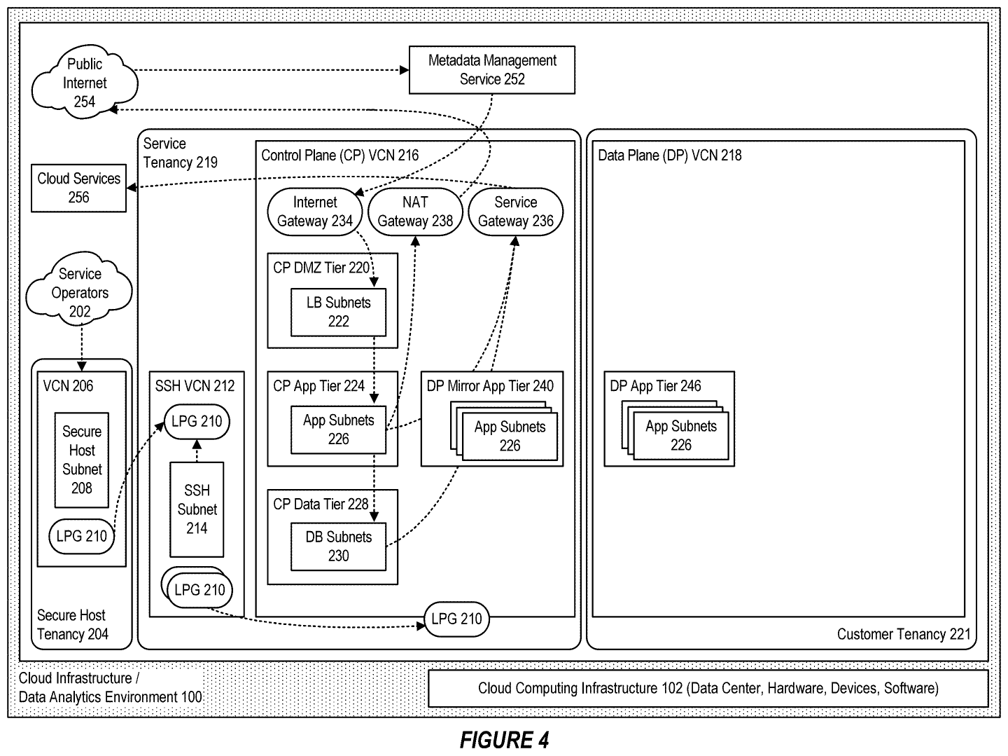

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources that are provisioned in the control plane VCN that is contained in the service tenancy, to be deployed or otherwise used in the data plane VCN that is contained in the customer tenancy.

In accordance with an embodiment, a customer of the cloud infrastructure provider may have databases that are managed and operate within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, of the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with Deployment 1 in Region 2.

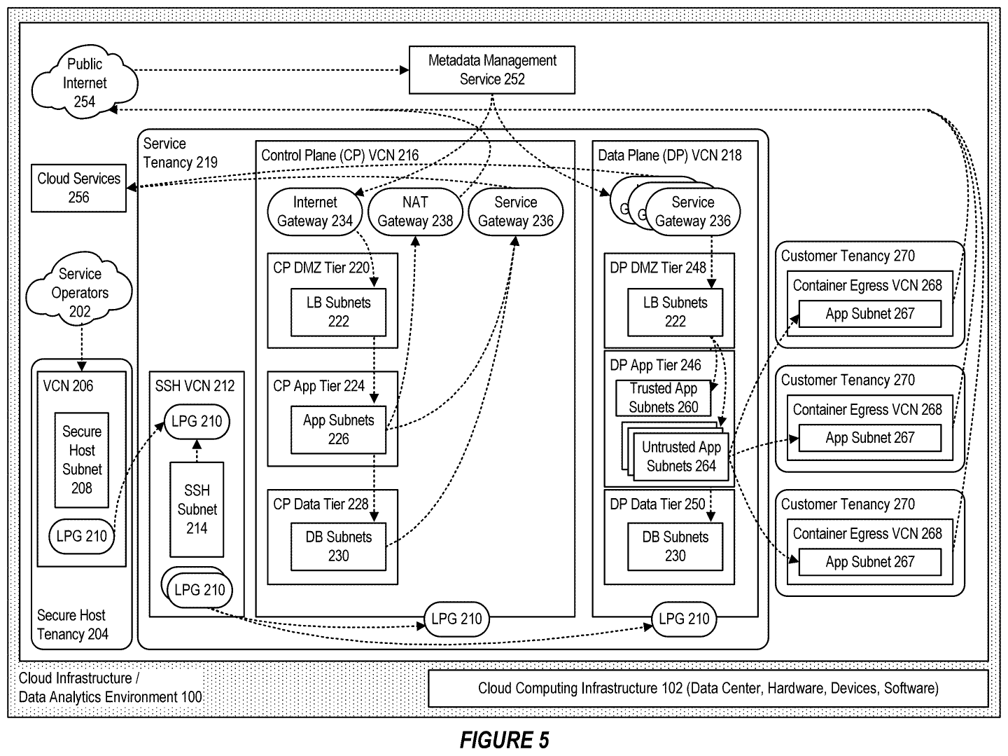

As illustrated in FIG. 5, in accordance with an embodiment, the trusted app subnet(s) 260 can be communicatively coupled to the service gateway contained in the data plane VCN, the NAT gateway contained in the data plane VCN, and DB subnet(s) contained in the data plane data tier. The untrusted app subnet(s) 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs, and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)), which may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s), and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled; or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

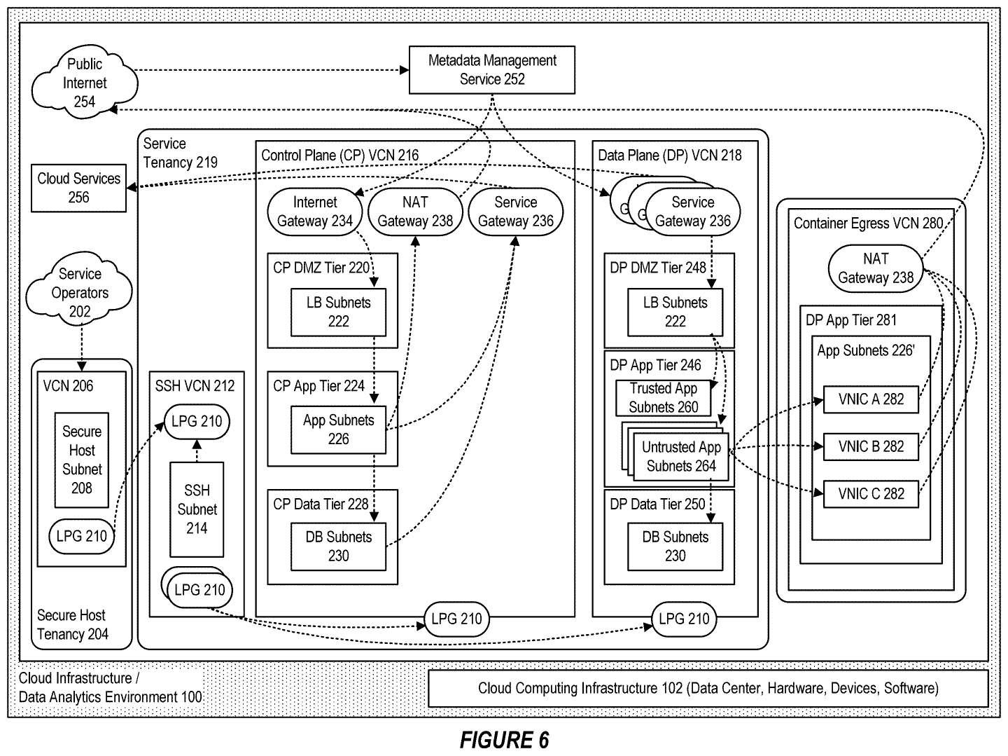

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container, and be communicatively coupled to an app subnet that can be contained in a data plane app tier 281 that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that requests a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

Object Storage Based Volume Service with Support for Filesystem Access

Embodiments described herein are generally directed to systems and methods for providing an object storage based volume service, with support for filesystem access, for storage and use of data within a cloud computing environment such as a cloud infrastructure or data analytics environment.

Generally described, a technical specification such as the Institute of Electrical and Electronics Engineers (IEEE) Portable Operating System Interface (POSIX) specification provides a range of industry standards for maintaining compatibility among operating systems. The use of a POSIX-based filesystem provided on top of object storage is particularly useful in various scenarios, for example:

Big Data Analytics: to provide seamless integration with mainstream computing engines (e.g., Spark, Presto, Hive), leveraging the scale and performance of object storage.

Gen AI Model Training/Serving: for services compatible with POSIX, that support machine learning and deep learning frameworks;

Shared Workspace: to provide a POSIX-based filesystem that can be mounted on any host, with no restrictions to client concurrent read/write; for example as may be used with OCI data flow and scripting operations to avoid a need for long URI paths.

Data Backup: to provide backup of data in a scalable storage space without limitation; combined with a shared mount feature, so that data from multiple hosts can be aggregated into one place and then backed up together,

However, there are challenges in providing POSIX-style access on top of an object store, which include, for example:

Data Integrity: an object store having a flat namespace lacks a concept of folders; hence both folders and files are mapped 1:1 to objects in object stores. Renames of folders requires bucket-level locking in the object store, and can lead to data integrity issues.

Performance: for large directories, renames and deletes are expensive operations since they involve renaming/deleting the object in the object store iteratively.

Embodiments described herein are generally related to cloud computing environments, such as cloud infrastructure or data analytics environments, and are particularly directed to systems and methods providing an object storage based volume service, with support for filesystem access.

In accordance with an embodiment, filesystem access can be provided in accordance with Portable Operating System Interface (POSIX) standards, for storage and use of data within the cloud computing environment. The system can virtualize a hierarchical namespace for use with mounted filesystem paths on client machines, wherein paths to folders or individual files are mapped to immutable identifiers (IDs) are stored in a metadata layer as path-to-IDS mappings. Operations such as folder or file renames or deletes can be performed efficiently and independently of the folders/files below, by respectively updating a new name for an immutable ID, or by removing the immutable ID from the path-to-ID mapping.

In accordance with an embodiment, the high-level approach is to separate out “metadata” and “data” operations. Metadata operations include the definition of logical entities, such as volumes, folders, and files; while data operations involve actual reading/writing of data to these files.

In accordance with an embodiment, the metadata operations can be provided by a combination of a volume service and data hub, which provides metadata storage and retrieval. The data operations can be directed to object storage (i.e., an object store) or data. For each volume service operation, there will be an initial metadata operation (e.g. finding the actual physical location of /Workspace/Users/SB1/ data/my_data.csv). Then, for the actual reading/writing to the file, the volume service will not be in the execution path; and instead the reading/writing of data will directly use object storage. In this way, the volume service does not need to scale to the data throughput being read/written to data hub volumes. The actual read and write of the data happens from the client node using a volume service client directly calling the object store, and volume service is not involved in the I/O execution.

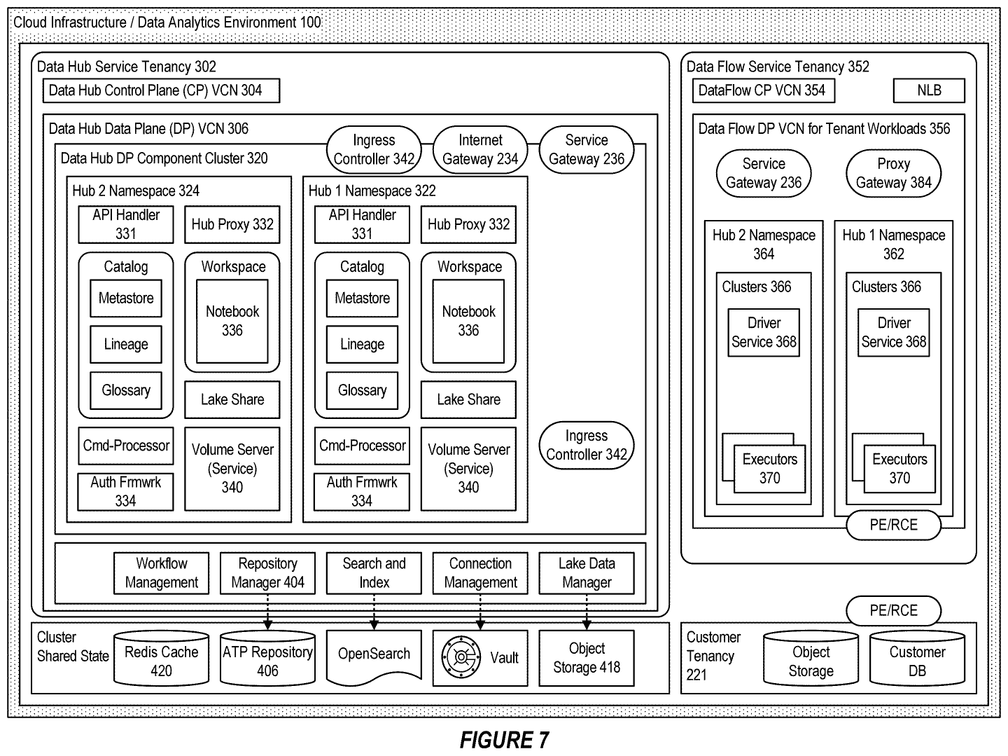

FIG. 7 illustrates how the system can be used to provide an object storage based volume service with support for filesystem access, in accordance with an embodiment.

In accordance with an embodiment, the cloud infrastructure environment stores data for use with, for example, one or more data hub service tenancy 302 or data flow service tenancy 352 having a control plane (CP) VCN 304, 354; data plane (DP) VCN 306, 356; data hub DP component cluster 320; namespaces 322, 324, 362, 364; clusters 366; and additional components as illustrated. A customer can access their data for various purposes or via cloud services, including for example via data analytics services running within the cloud infrastructure environment and operates as a data analytics environment.

In accordance with an embodiment, the system can include at a backend a data store that uses object storage 418 and which provides high throughput. However as described above, the usability of object storage is difficult since a typical object storage resource does not natively provide a folder-type data structure. As described herein, the system can provide the scalability of object storage, but with improved user experience, including allowing a user to access their storage backend as a regular filesystem, for example to list or organize folders and files,

In accordance with an embodiment, the system can operate as a data hub service, comprising a volume server (service) 340 that provides a storage part of the data hub, and also provides access to data stored or provided by other components such as databases, data lakes, or data pipelines. This allows the volume service to provide a file-based storage mechanism which is abstracted from the underlying, e.g., database or data lake; and which provides a usability layer, mapping a hierarchy of folders and files into the flat namespace of the object storage.

In accordance with an embodiment, this mapping provided by the volume service can be provided as a metadata in the volume service, for example by mapping the relationships between each file entity's parent and child, and storing that information in a table. When the volume service is used to find, move, or delete a particular file, it can use the table to find the relationship.

For example, in accordance with an embodiment, in the folder table, if the volume service is instructed to delete a particular folder, it can delete the corresponding ID from the table. Since this action will sever the parent-child link, not nobody can thereafter access the data in the folder. A background process can then clean up the broken links at a later point.

In accordance with an embodiment, the described approach to providing file-based access provide several advantages, including leveraging object storage for throughput and scale, while supporting the use of file-based access in additional use cases and integrations, such as for example, with Linux-based applications that utilize filesystems.

In accordance with an embodiment, the described approach is also suited to performing data analytics at scale; including use cases such as: Building a data lake and ETL pipelines; Real time streaming analytics; Data sharing and governance; and Building apps such as, for example, recommendation engines, predictive analytics through deeper integrations between the data hub and Data Science, Gen AI or other AI-related services.

In accordance with an embodiment, users can query and output tabular and non-tabular data sets.

Examples of tabular data sets include tables and views with a well-defined schema and typically persisted in object storage in Parquet, or Delta formats.

Examples of non-tabular data sets include CSV, JSON files, images, videos, log files, libraries and scripts to be installed on data hub computer clusters.

In accordance with an embodiment, users can define “volumes” and within those volumes create/manage files and folders-which can then be read/written/updated to by their code executed within Notebooks or workflows by referencing the files in a POSIX format, for example /Volumes/catalog1/schema1/volume1/folder1/foobar.csv. Similarly, data can be read, written, and updated using standard POSIX-based filesystem access methods.

In accordance with various embodiments, the system can include or utilize some or all of the following features:
Data Hub/Data Fabric: a data hub is a center of data exchange that is supported by data science, data engineering, and data warehouse technologies to interact with endpoints such as applications and algorithms.
Namespaces: in Kubernetes, namespaces provide a mechanism for isolating groups of resources within a single cluster. Names of resources need to be unique within a namespace, but not across namespaces. Namespace-based scoping is applicable only for namespaced objects (e.g. Deployments, Services) and not for cluster-wide objects (e.g. StorageClass, Nodes, PersistentVolumes).
Pod: a pod is a group of one or more containers, with shared storage and network resources, and a specification for how to run the containers.
Compute cluster: Compute refers to the selection of computing resources the user can provision in their data hub workspace. These may be customer specific clusters running on a data flow service, or that run untrusted code such as, for example, code executed from notebooks. In accordance with an embodiment, the system can use Spark execution engines.
Catalog: a catalog, for example a Centrify Catalog, provides a unified way to catalog and govern structured and unstructured data which can include, e.g., object storage, Kafka, ADW.
Hive Metastore Service (HMS): a Hive metastore service is a fully managed metadata service that provides relational metadata such as, for example, database, table, or partition projected against structural data on object storage.
Object Storage Bucket: buckets are logical containers for storing objects in Oracle Cloud.
Role Based Access Control (RBAC): RBAC is based on the concepts of users, roles, groups, and privileges in an organization. Administrators grant privileges or permissions to pre-defined organizational roles that are assigned to principals or users based on their responsibility or area of expertise. RBAC simplifies the administration of data access controls because concepts such as users and roles are well-understood constructs in a majority of organizations.
Repository Manager 404: a shared service handling data plane (DP) metadata managed by a data hub into a common autonomous transaction processing (ATP) service and providing streamlined access to the database.
FUSE: a Filesystem in Userspace (FUSE) is an interface for user space programs to export a virtual filesystem to the Linux kernel.
Data Hub FS: a hub filesystem that handles the filesystem operations on hub cluster pods/workspace pods.
Hub Proxy 332: provides routing/AuthN/AuhZ for all west-east data plane traffic between a data hub data plane and a data flow data plane.
API Handler 331: a data plane API handler pod that runs a RESTful service for data plane (DP) components.
Authorization (Auth) Framework 334: an, e.g., Apache Ranger or other instance that can be used to manage RBAC policies for data hub related entities.
POSIX: a set of standard operating system interfaces based on the UNIX OS
Data Hub Notebook 336: data hub notebooks are Jupyter-based interactive coding environments for performing data preparation and ML model training. They support code in Python, PySpark, Scala, or SQL. Notebooks use the compute clusters for the runtime environments. Notebooks will seamlessly integrate into the data hub experience, allowing for easy code development. Notebooks are Jupyter-based interactive coding environments for performing data preparation and ML model training. They support code in Python, PySpark, Scala, or SQL.
Autonomous transaction processing (ATP) repository 406: an autonomous transaction processing service or repository.
OKE cell: the cell architecture is a pattern used for identifying resource affinities, grouping consumers based on access patterns, defining performance and capacity pools; which operates as a logical concept used to identify the components (e.g., OKE) of a service stack that can be grouped as a unit of scale and isolation.
Non-Tabular dataset: examples include raw CSV, JSON files, images, videos, log files, libraries, and scripts.
Volume: volumes are catalog objects representing a logical volume of storage in object storage locations in hub. Volumes provide capabilities for accessing, storing, governing, and organizing files. A volume can provide a logical storage of files and folders meant for non-tabular data and can be governed by customer defined RBAC policies. Volumes are similar to tables but meant for non-tabular data.

Managed volumes—a simpler experience for customers where data hub service manages the lifecycle of volume contents.

External volumes—allows customers to create logical volumes on existing data sets in their tenancy. The data hub service does not manage the lifecycle of the volume contents. For example, if an external volume is deleted by the customer, data hub service will not delete the underlying data. Another reason why customers might opt for external volumes is if the data has to be shared by other tools/services other than data hub.

Workspace: a workspace is a data hub deployment in the cloud that functions as an environment for a user to access hub assets. A data hub workspace is an integrated environment that comprises of compute clusters, workflows and notebooks. A customer can have spin up multiple workspaces within a data hub instance (e.g., team or line of business specific). With respect to volume service, a workspace is a special volume with subtle differences: Workspace allows finer access control measures at file/folder level. Workspace have tighter restrictions in terms of size and number of files. Workspace files cannot be shared across workspaces (unlike a typical volume).

In accordance with an embodiment, the components within a data hub data plane are deployed per hub instance. These components are therefore isolated in terms of, for example, deployment, connectivity, or ability to scale. The volume service follows a similar model where it is deployed as a microservice with a dedicated infrastructure footprint per data hub instance.

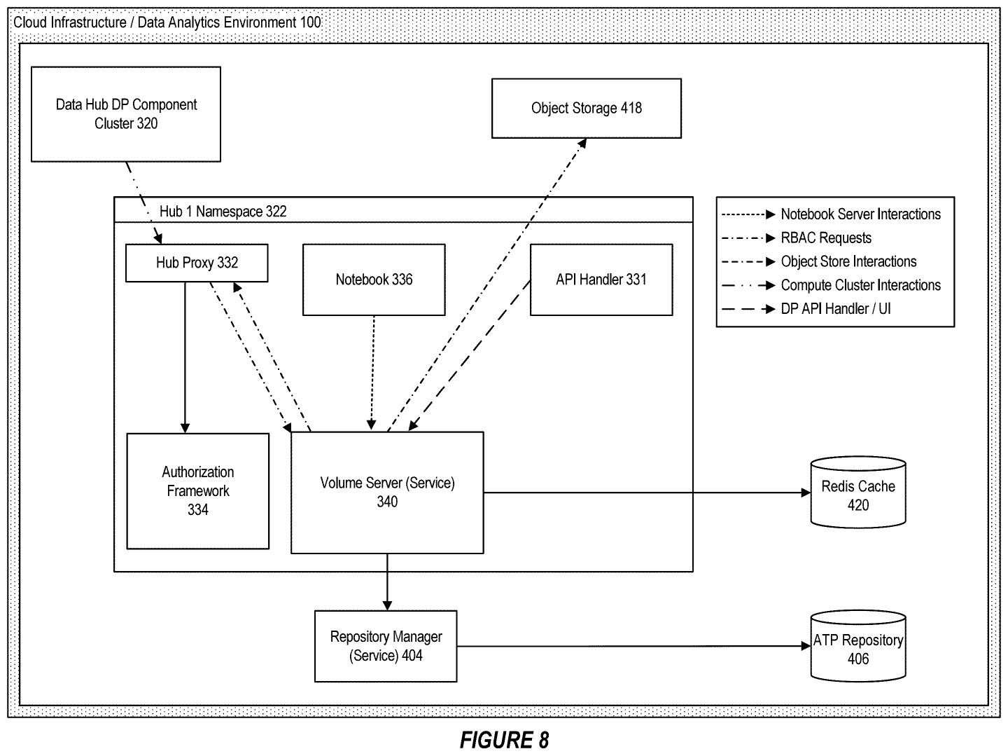

FIG. 8 further illustrates use of an object storage based volume service with support for filesystem access, in accordance with an embodiment.

In accordance with an embodiment, the volume service provides API support for CRUDL operation on volumes as well as files and folders within such volumes. It can also facilitate reads/writes from object store data; and can expose a custom client built on top of a SDK based Java client and a Python client which can be integrated with consumers to interact with the volume service. The volume service can be running within the hub data plane within a hub namespace.

In accordance with an embodiment, a volume service client library provides custom logic for specific operations needed to support the downstream consumers such as, for example, Data hub FS, data plane (DP) API handler and compute cluster. Example of such capabilities include support for reads/writes from object store, or file updates.

In accordance with an embodiment, a data plane (DP) API handler exposes public facing API's to upload, download folders/files to volumes and workspaces which are then consumed by the data hub UI. The volume service client will connect to the volume service for handling all the volume related metadata operations. Volume and file/folder associated metadata will be persisted in ATP which operates as an authoritative source-of-truth. This metadata will be cached, for example in Redis 420, using a cache service.

In accordance with an embodiment, Ranger can be used as the policy store where the security policies containing the RBAC roles and permissions are stored. The hub proxy maintains the Ranger policy cache where RBAC checks are done.

In accordance with an embodiment, the volume service, before performing any operation, first validates from the hub proxy, whether the end-user has required set of permissions to carry out the ongoing operation. In case of a missing required RBAC permission, the requests fail with a message clearly indicating the user has missing permission for the current operation.

In accordance with an embodiment, the Repository Service handles the interactions with the shared ATP resource in data hub.

### Data Modelling and Persistence

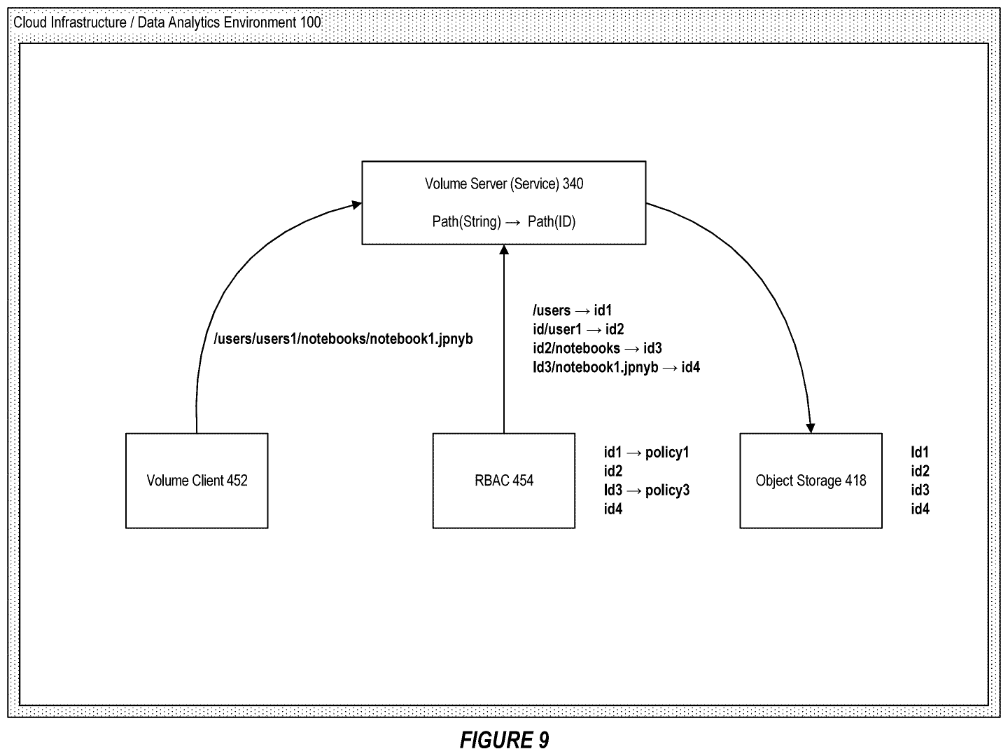

FIG. 9 further illustrates use of an object storage based volume service with support for filesystem access, in accordance with an embodiment.

In accordance with an embodiment, instead of maintaining the file/folder hierarchy in, e.g., Object Store, Ranger, the volume service operates to maintain the folder/file hierarchy 480 for fast look up, list, rename and delete operations.

In accordance with an embodiment, at the RBAC layer 454 the system operates with a flat hierarchy that is not subject to change upon rename/move. For example, the file “/users/user1/notebooks/notebook1.jpynb” is mapped in volume service and then laid out within, e.g., Ranger, and the object store.

In accordance with an embodiment, the volume service client (volume client) 452 will create a file “/users/user1/notebooks/notebook1.jpynb”. At the volume service level, this path will be broken down into path components where volume service will maintain the path to ID mapping, and RBAC (e.g., Ranger) security policies will only refer to IDs and in object store, the objects containing the data will be referred by IDs only.

In accordance with an embodiment, the system uses three (volume, folder, file) tables where the volume/file/folder metadata will be mapped and persisted and an additional table each for supporting async deletion.

### Volume Table

In accordance with an embodiment, the volume table will contain details of the volume metadata itself. The below example shows how a volume called volume1 will be persisted.

| Volume | Attributes |
|---|---|
| /datahub1/catalog1/ | vol_Id - ID of the volume |
| schema1/volume1 | location: bucket1/schema1/vol_id/ |
| | owner: SB1 |
| | isExternal: false |

### Folder Table and File Table

For example, if one considers two files /volume1/users/user1/notebooks/notebook1.jpynb and /volume1/users/user1/notebooks/notebook2.jpynb, then the content of the folder table and the File table are listed below.

In accordance with an embodiment, the folder table maps directory name to IDs where each path segment appears only once in the table no matter how many child folders below it. Both folder and file table will map the paths to the IDs. This will also track the folder creator information. Folders can have some special characteristics such as, for example, Shared folders which can never be renamed/deleted or deleted and System folders which are not visible to workspace users. The vol_id is the ID of the volume in the volume table.

| Key | Attributes |
|---|---|
| vol_id/users | id: id1 |
| | owner: SB1 |
| id1/user1 | id: id2 |
| | owner: SB1 |
| id2/notebooks | id: id3 |
| | owner: SB1 |

In accordance with an embodiment, the file table map files at the leaf of the hierarchy to their IDs.

| Key | Attributes |
|---|---|
| id3/notebook1.jpynb | id: id1000 |
| | owner: BV1 |
| id3/notebook2.jpynb | id: id1001 |
| | owner: SB1 |

In accordance with an embodiment, owner information is kept along with volume, file and folder metadata so that, no new RBAC (e.g., Ranger) policies need to be set to allow the creators/owners to access the resources. This also helps in reducing the number of RBAC policies.

### Deletion Table

In accordance with an embodiment, the deletion table tracks all the folder/file to be deleted. In later section, we will illustrate how the deletion will be asynchronously done and consistently.

| Key | Attributes |
|---|---|
| 1000 | id3/notebook1.jpynb |
| 1001 | id3/notebook2.jpynb |

### Tag Table

In accordance with an embodiment, to support rich metadata of data hub on file, folders, the system can include an additional table to track the file/folder tag/attributes. An entry will be added only if customers explicitly added tag/attribute to the file/folder. These IDs will be tracked and stored in ATP from where it can be referred to track job definitions, notebook attachments, support any user defined tags on folders/files. For specific cases such as when data hub needs to track a file by id, e.g. a data hub job object points to a job-def file, data hub workflow service will call volume service to request file-id for job-def file (identified by path). At this point, volume service will also add the path as an attribute for such files in the tag table. When the file needs to be accessed later (and path may have changed), data hub workflow service calls Volume-Service with file-id and receives back the current file/folder name.

| Key | Attributes |
|---|---|
| id1002 | ClusterJob |
| id1001 | notebook |
| id1000 | notebook |

### Operations-Volumes

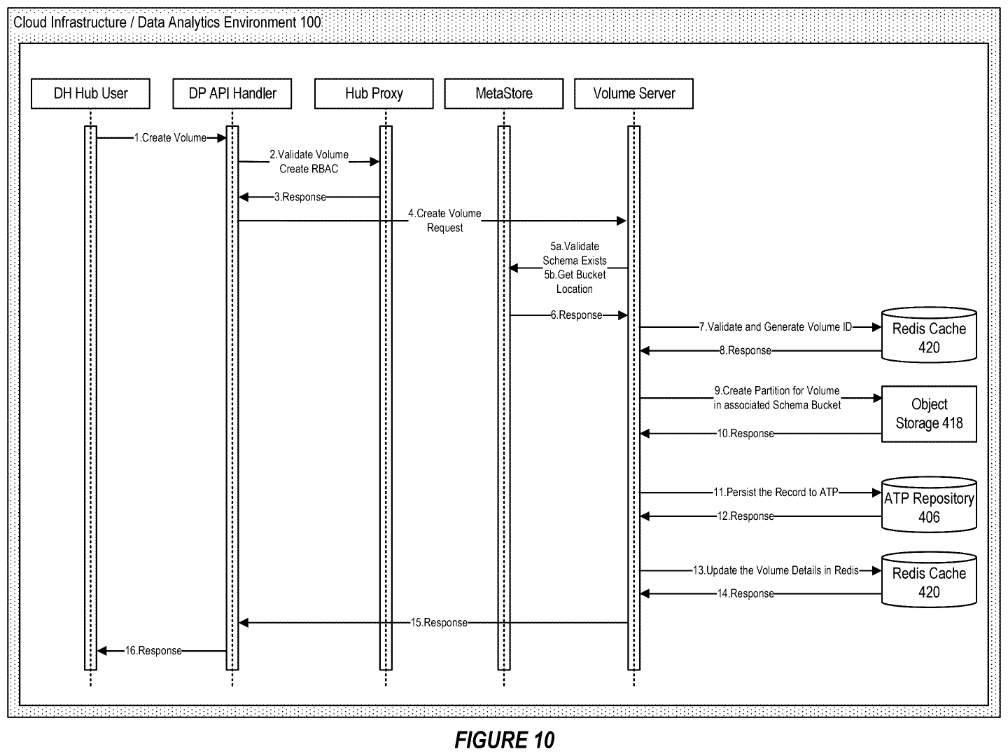

FIG. 10 further illustrates use of an object storage based volume service with support for filesystem access, in accordance with an embodiment.

In accordance with an embodiment, the volume service comprises various modules including: a volume request handler—which handles the incoming request, performs basic semantic checks, extracts the user information and hands it over to a file operation handler; the file operation handler—which handles the business logic required to handle the operation, and performs an RBAC check if necessary; and a state manager—which handles all the interactions and mutations with Redis and ATP.

As illustrated in FIG. 10, in accordance with an embodiment, a create volume request from user will be received on the data plane (DP) API handler. The request is validated and then sent over to the volume service within the hub namespace. The request is then validated for RBAC by calling the hub proxy.

Subsequent to successful RBAC evaluation, a response is sent from the hub proxy. The volume server/service then calls a metastore (e.g., HMS) for validating the schema and gets the bucket location associated with the schema. The metastore response is sent back to the volume server/service.

For a new volume, an ID is generated in Redis. The response from Redis is processed. The generated file ID will be used to create the object in the object store. An object is created within the bucket for the associated schema which defines the sub-folder (partition) under which all the objects inside managed volumes will reside. The object storage response is processed. The volume record is then persisted to an ATP table, including the location details of the volume along with the associated catalog and schema details. The response is sent back to the volume server/service from the repository manager/ATP. The volume record is updated in the volume table in Redis. The response from Redis is sent back to the volume server/service. The response is then sent back to the data plane (DP) API handler, which sends the response back to the data hub user.

### Operations—Create

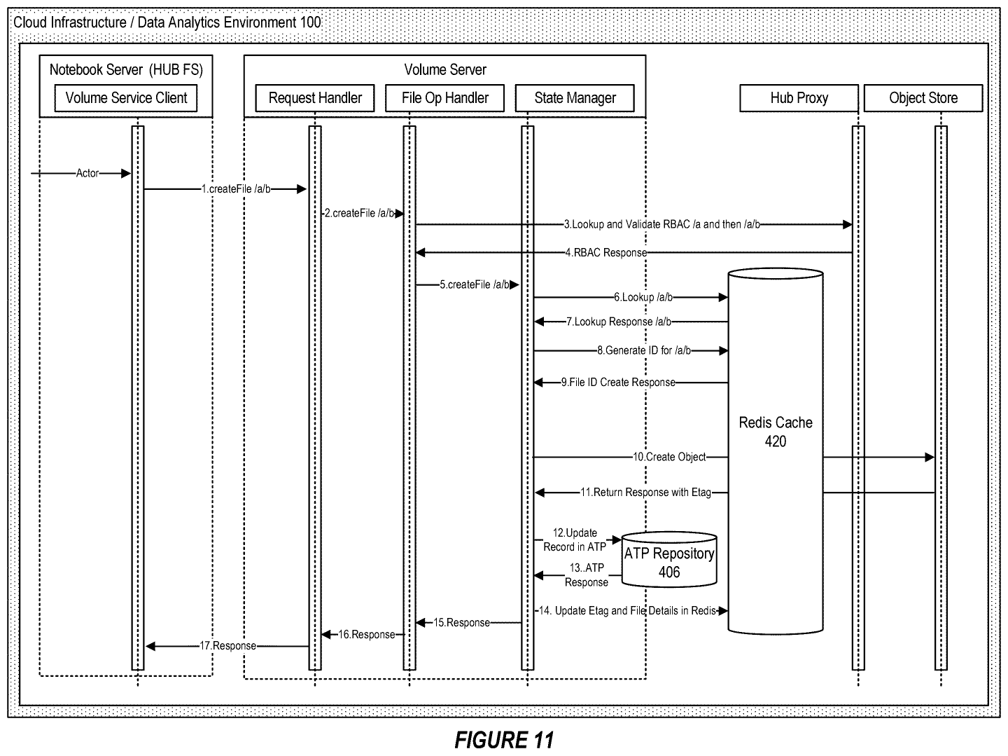

FIG. 11 further illustrates use of an object storage based volume service with support for filesystem access, in accordance with an embodiment.

As illustrated in FIG. 11, in accordance with an embodiment, a create file request from the volume service client will be received on the request handler module in the volume server/service. The request is validated and sent over to the file op handler module in the volume server/service. The request is then validated for RBAC by calling hub proxy.

Subsequent to successful RBAC evaluation in the hub proxy, a response is sent from the hub proxy. If the RBAC check succeeds, the request is handed over to the state manager. The file metadata is looked up again in the Redis cache, to ensure the file still exists, and the lookup response is processed.

If the file does not exist already, a unique ID is generated. Subsequent to ID creation, a response is processed in the state manager. The generated file ID will be used to create the object in the object store. The object storage response is processed. The file record is then persisted to ATP with updated ETag. The ETag of the file generated along with volume details such as, for example, file id, creation time, and owner information, is updated back in file table in Redis. A response is then sent back to the volume service client, including location details of file, ETag and size of the file.

### Operations—Rename/Move

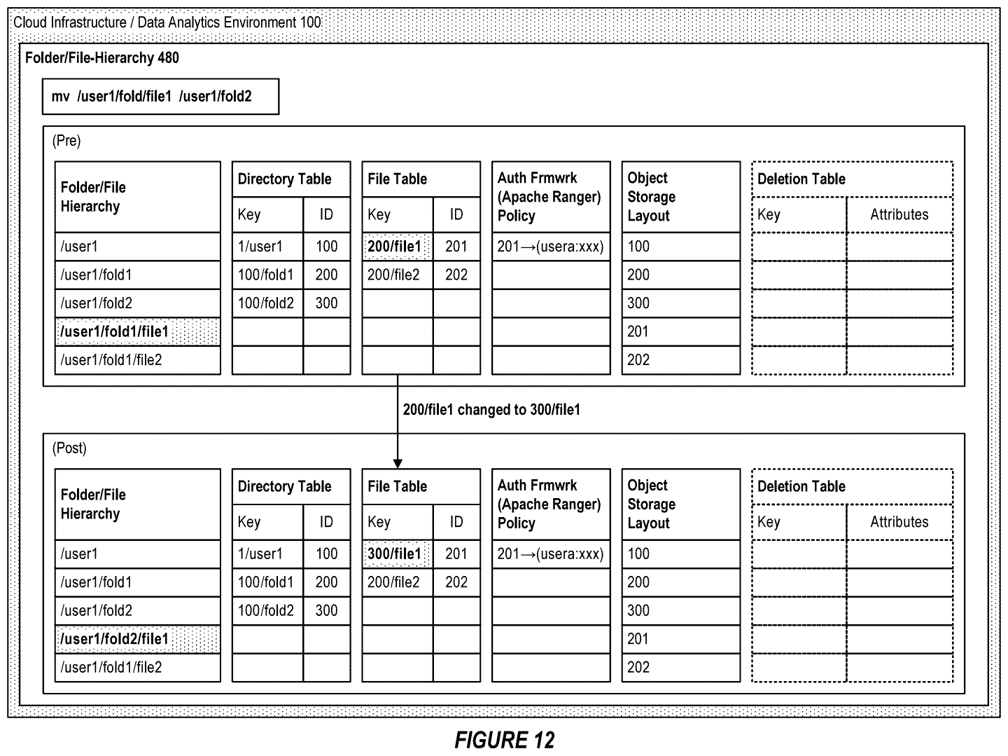

FIGS. 12-14 further illustrate use of an object storage based volume service with support for filesystem access, in accordance with an embodiment.

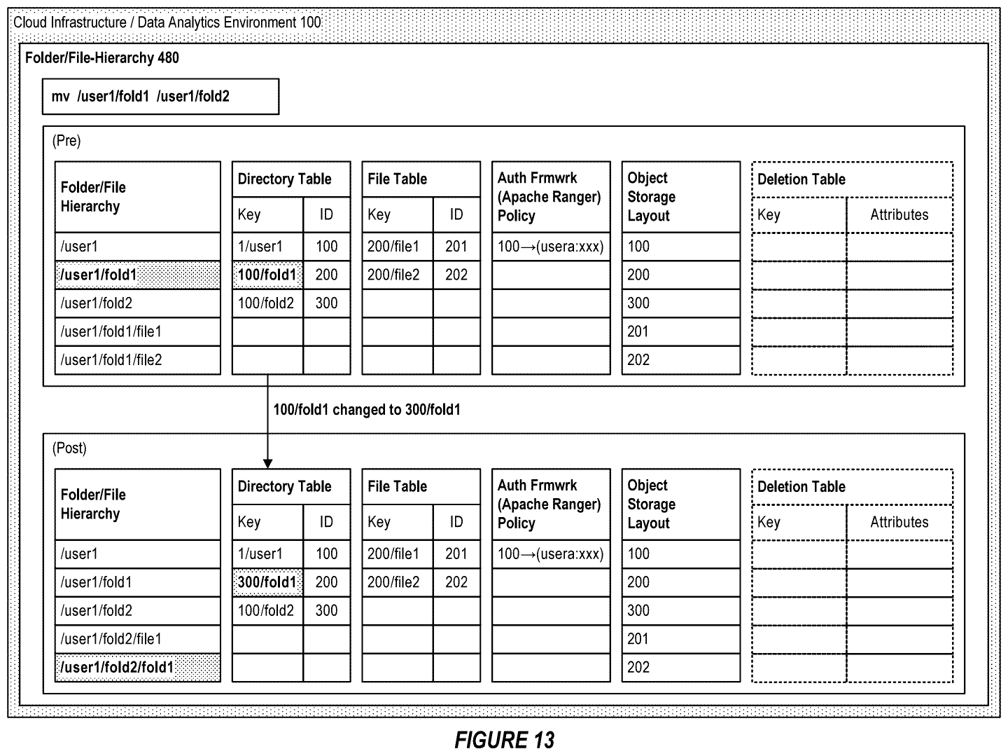

As illustrated in FIGS. 12-13, in accordance with an embodiment, a rename/move operation comprises simply a metadata change. It does not require any mutations in either object store or anywhere else. Irrespective of the depth of the folder tree structure, rename can always be achieved in o(1) time.

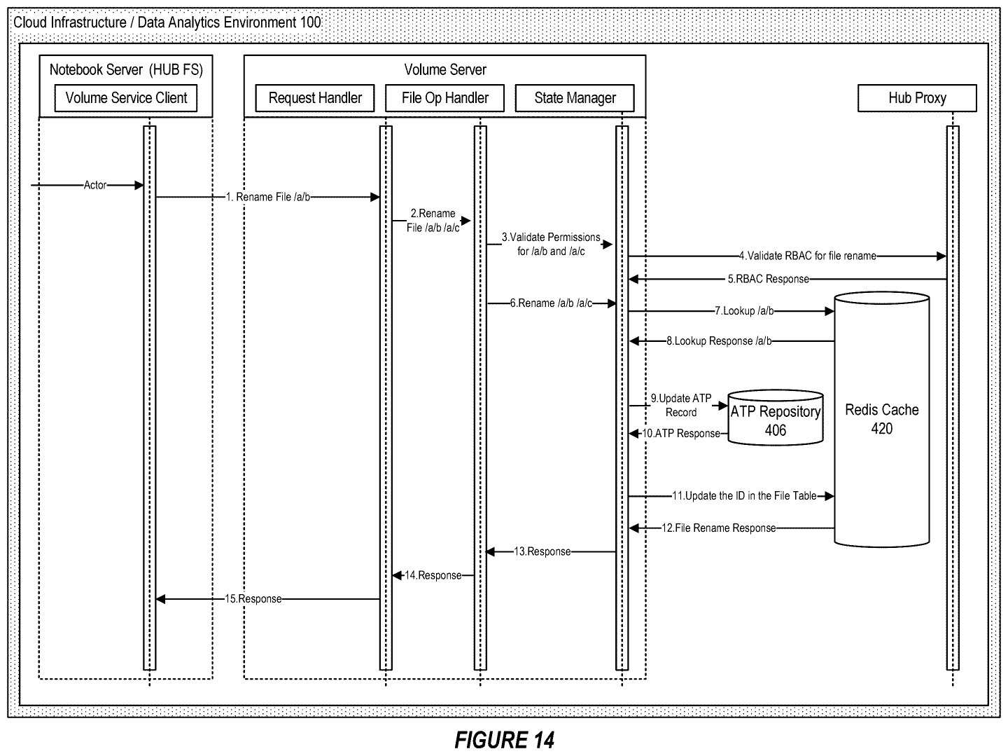

As illustrated in FIG. 14, in accordance with an embodiment, a rename file/folder request from volume service client will be received on the request handler module in the volume server/service. The request is validated and sent over to the file op handler module in the volume server/service. The request is then validated for RBAC by calling hub proxy.

Subsequent to successful RBAC evaluation in the hub proxy, a response is sent from the hub proxy. If the RBAC check succeeds, the request is handed over to the state manager. A rename request is handed over to the volume state manager. The file is first looked up again in the Redis cache. Lookup response is processed.

If the src exists and target is validated, the ATP record of the key containing the parent ID is updated to the target parent in directory table for folders and in file table for files. A response from repository manager/ATP is sent back. The Redis record is now updated with updated parent. A response is then sent back to the volume service client.

### Operations—File Move/Folder Move/Async Deletion

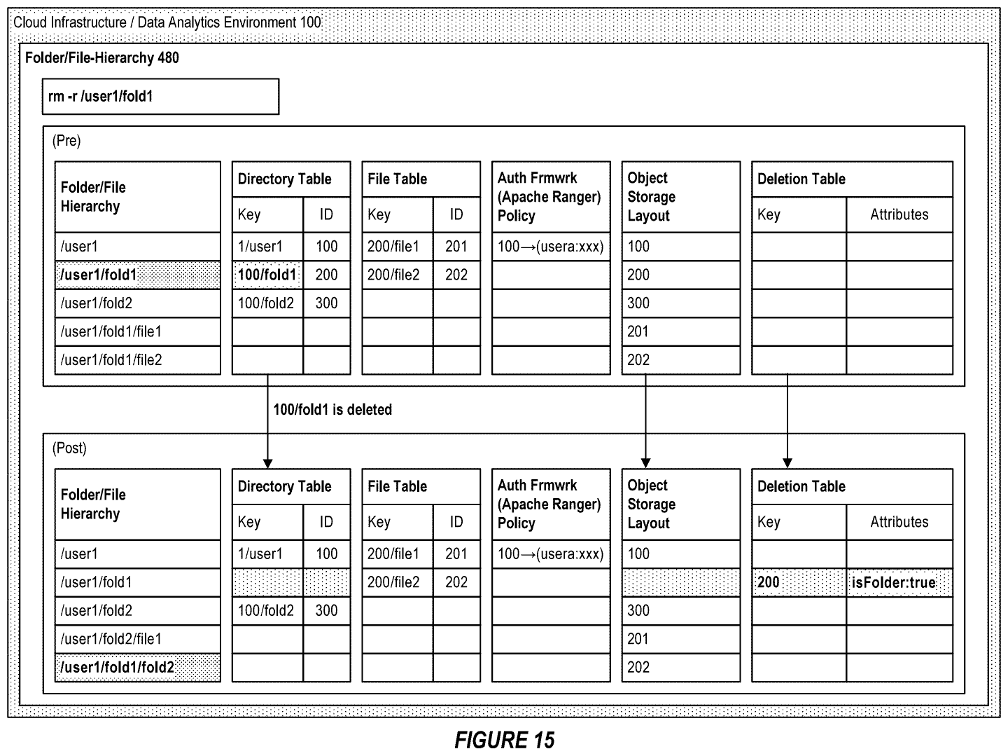

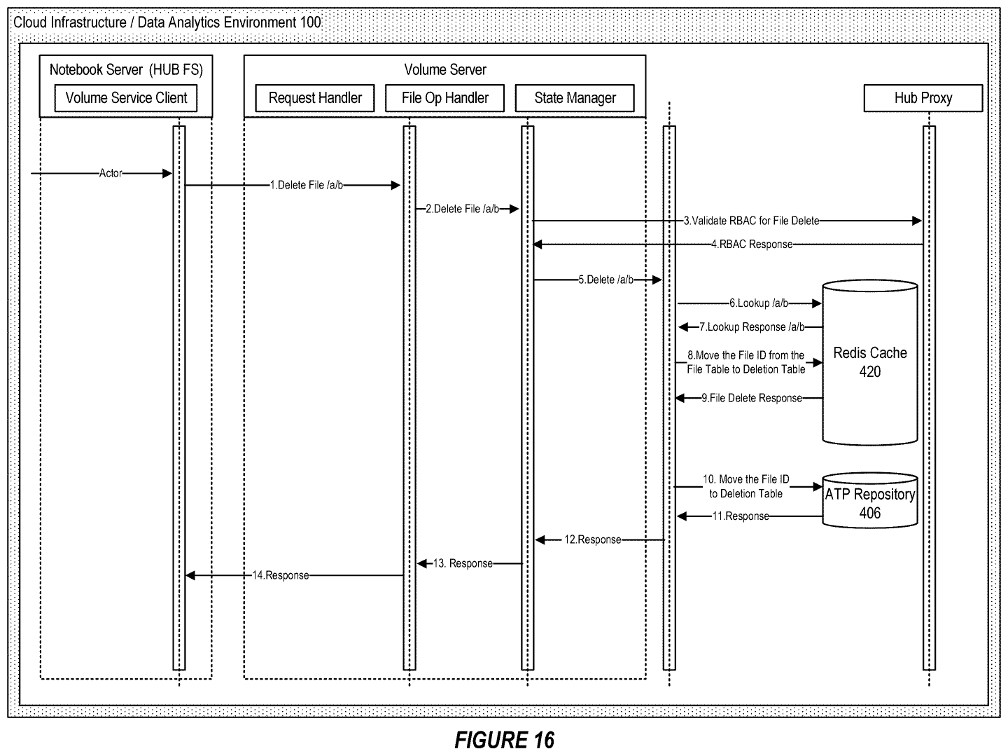

FIGS. 15-16 further illustrate use of an object storage based volume service with support for filesystem access, in accordance with an embodiment.

As illustrated in FIG. 15, in accordance with an embodiment, a deletion comprises simply removing the folder entry from directory. All the files beneath the folder along with data and policies in RBAC (e.g., Ranger) can be cleaned up asynchronously. Once a file/folder is deleted, the entry is removed from the file table and added into the deletion table which holds the deleted entries. A garbage collector thread running within the volume service will scan the deletion at a configurable regular interval which read the entries from the deletion table and clean up the corresponding object store object and RBAC policy if any.

As illustrated in FIG. 16, in accordance with an embodiment, a delete file/folder request from volume service client will be received on the request handler module in the volume server/service. The request is validated and sent over to the file op handler module in the volume server/service. The request is then validated for RBAC by calling hub proxy.

Subsequent to successful RBAC evaluation in the hub proxy, a response is sent from the hub proxy. If the RBAC check succeeds, the request is handed over to the state manager. The file is first looked up again in the Redis cache; and a lookup response is processed.

If the src exists, the corresponding ID from the file/folder is added to the deletion table and the entity is marked for async deletion. A response is processed in the state manager. The response is then sent back to the volume service client.

### Operations—Write

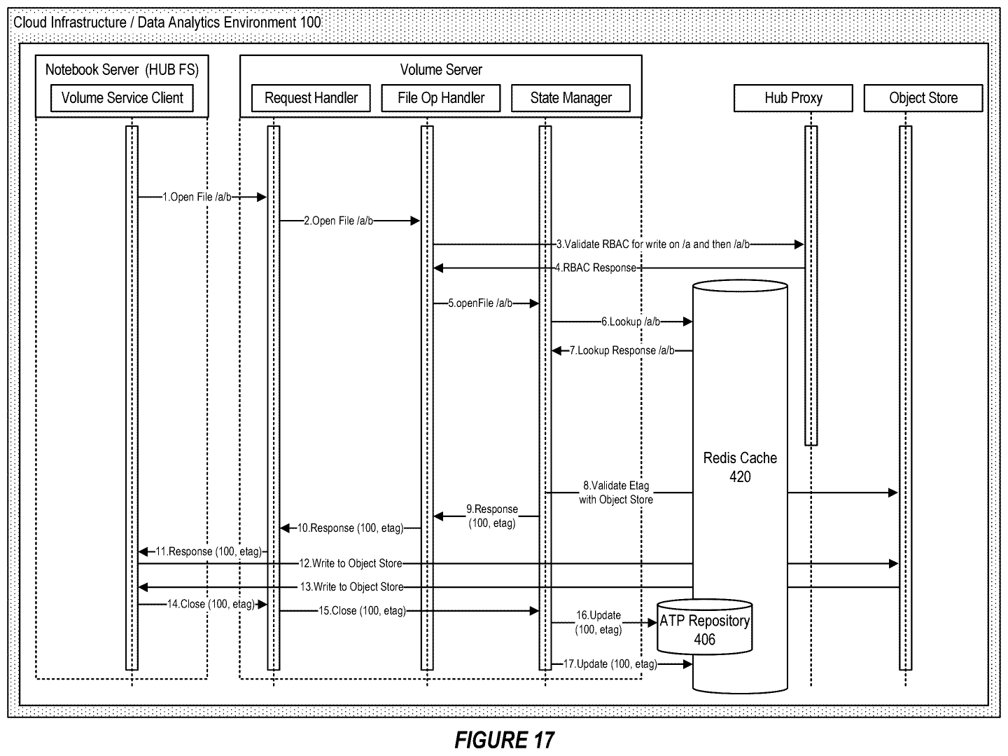

FIG. 17 further illustrates use of an object storage based volume service with support for filesystem access, in accordance with an embodiment.

In accordance with an embodiment, for file write, an open call at start to read the file specific metadata and a close call at the end to update the file metadata such as, for example, size and ETag will be initiated to the volume server/service. The volume server/service will not be in the path of actual writes as writes from the client will directly go to object store and hence it will not impact any scale, throughput or latency of writes.

As illustrated in FIG. 17, in accordance with an embodiment, an open for write file request from the volume service client will be received on the request handler module in the volume server/service. The request is validated and sent over to the file op handler module in the volume server/service. The request is then validated for RBAC by calling hub proxy.

Subsequent to successful RBAC evaluation in the hub proxy, a response is sent. If the RBAC check succeeds, the request is handed over to the state manager. The file is first looked up again in the Redis cache.

If the file exists, file location along with the latest ETag is passed back in response. The response is processed in the state manager. The ETag is validated again with the corresponding object in object store, to ensure the cached ETag is still valid. If not, then both Redis and ATP will be updated with latest ETag and size. Response is then sent back to the volume service client.

The volume service client internally instantiates an object storage client to write to the object store with the location and latest ETag received. The object in the object store is written from the client directly. A close is initiated from the volume service client to the volume server/service. The request handler in volume service receives and validates the close request.

The file operation handler in the volume performs an RBAC check, validates the existing file metadata, and calls the state manager to update the size and latest ETag of the file. The state manager in the volume service then interacts with ATP to update the latest ETag and size of the file. The state manager in the volume service then interacts with Redis to update the latest ETag and size of the file.

### Operations—Read

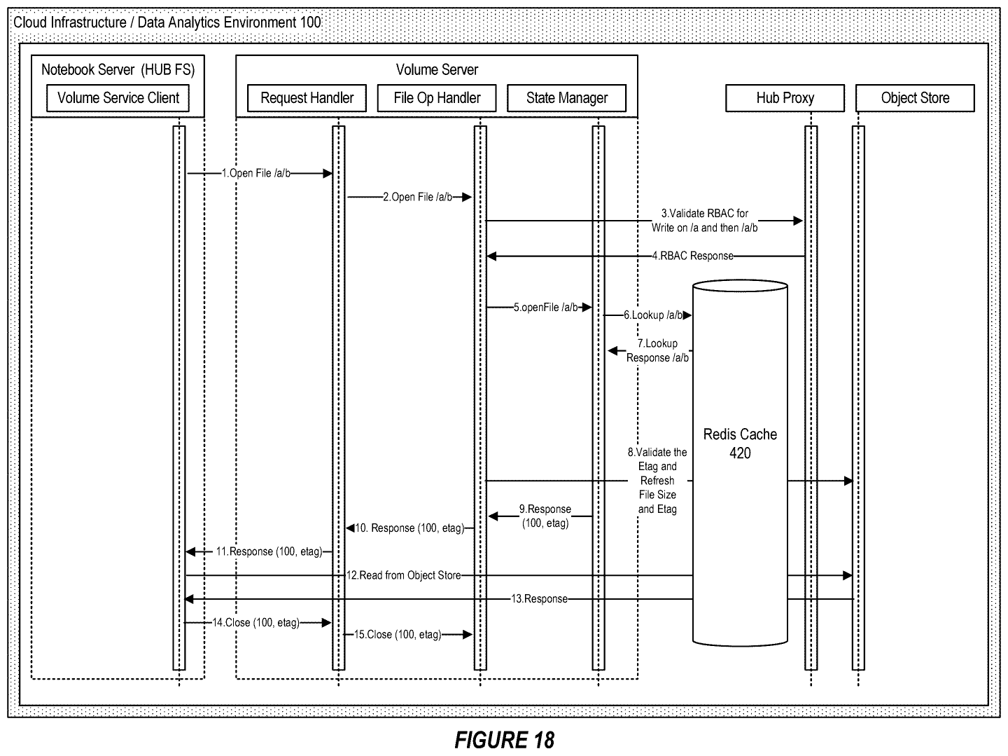

FIG. 18 further illustrates use of an object storage based volume service with support for filesystem access, in accordance with an embodiment.

As illustrated in FIG. 18, in accordance with an embodiment, an open for read file request from volume service client will be received on the request handler module in the volume server/service. The request is validated and sent over to the file op handler module in the volume server/service. The request is then validated for RBAC by calling hub proxy.

Subsequent to successful RBAC evaluation in the hub proxy, a response is sent. If the RBAC check succeeds, the request is handed over to the state manager. The file is first looked up again in the Redis cache.

If the file exists, the file location along with the latest ETag is passed back in the response. The response is processed in the state manager. The file ETag is revalidated with the object ETag from object store and cache is updated refreshed with size and ETag. If not, then both Redis and ATP will be updated with latest ETag and size. A response is then sent back to the volume service client.

The volume service client internally instantiates an object storage client to read from the object store with the location info and latest ETag received. The object in the object store is read from the client directly. A close is then initiated from the volume service client to the volume server/service. The request handler in volume service receives the request, performs validation and hands over the close call to the file op handler. The file op handler then validates the ETag, size sent from the client with the local metadata in Redis to ensure the file read is not changed or corrupted.

### Concurrency Semantics

In accordance with an embodiment, the system can include optimistic concurrency control measures. Object storage state concurrency control for data read/write, can be achieved by using ETags. Each object in object storage is assigned a unique ETag when it is created or updated (replaced). When PUT, POST and DELETE requests for the object store specify a first-writer-wins concurrency policy, then the request needs to provide the actual ETag value for the state to be written or removed for the request to be successful. The ETag of the remote object can be persisted in object store along with file/folder metadata in Redis. Every time during an fsync/flush/close of the file, the local value of ETag will be supplied in the corresponding PUT/POST/GET/DELETE requests in an if-match header. Object storage will execute the corresponding operation only if the if-match header value received from client matches what exists on the object storage server, otherwise the operation will fail. This will ensure there is no overwrite in case of concurrent writers to the same file in object store.

### Consistency

In accordance with an embodiment, for file reads and writes, the consistency guarantee made by the volume service is close-to-open consistency, wherein changes are flushed to the object store on closing the file. When the file is re-opened and read, the latest data will be read from object store. For metadata operations, clients will see a consistent view of the file/folder hierarchy. Metadata mutations can be provided within a transaction boundary by leveraging transactions in Redis and transaction guarantees of ATP.

### Availability and Durability

In accordance with an embodiment, volume service metadata can be stored in Redis. The volume service can be deployed as a micro-service within an OKE pod with a minimum replication of 2 to ensure there are multiple replicas of the volume service running at any point of time. The Redis cluster can be deployed with a multi-node setup to minimize the risk of losing the cache. Redis metadata tables can be backed by ATP, which will be used to serve the data in case the Redis cluster shuts down.

### Observability

In accordance with an embodiment, metrics such as usage or performance can be collected from the volume server/service and emitted to a telemetry endpoint which can be used for setting up alerts in production deployments and to provide metric visualizations. Example metrics that can be monitored include: aggregate write throughput (bytes/second); aggregate read throughput (bytes/second); aggregate bytes read; aggregate bytes written; latency metric for each operation; and request count metric for each operation.

### Scaling

In accordance with an embodiment, the volume service can be deployed on a separate infrastructure per data hub instance, which provides benefits in terms of reducing noisy neighbor issues across tenants and also reducing variations in infrastructure-scaling based on spikes in customer workloads. Example scaling dimensions can include: requests to each volume service (specific to a data hub instance and hence a tenant); total number of requests across all data hub instances (which will impact the cache lookups); and total size of metadata-which is dependent on the total number (across all customers) of volumes, folders and files defined by customers. The metadata can be cached in Redis which needs to scale in memory size if needed.

### Disaster Recovery

In accordance with an embodiment, the volume service caches the metadata for files/folder/volumes in Redis. The metadata is persisted in ATP, which is configured for periodic backup. The Redis (cache) can be restored either from ATP or can be configured to enable AOF (Append Only File) and snapshot at predefined intervals.

Single Tenant Vs. Multi-Tenant Architecture

In accordance with an embodiment, the volume service is dependent on components such as, for example, RBAC (e.g., Ranger) and metastores which are single tenant. For example, for every request for a workspace file or folder, a request to RBAC (e.g., Ranger) will be sent for access verification from volume service. The volume service will also listen to metastore events, for example a dropping of a schema where all associated volumes need to be deleted. In a multi-tenant architecture, the volume service can listen to events of multiple metastores.

### Workspace Creation Sequence

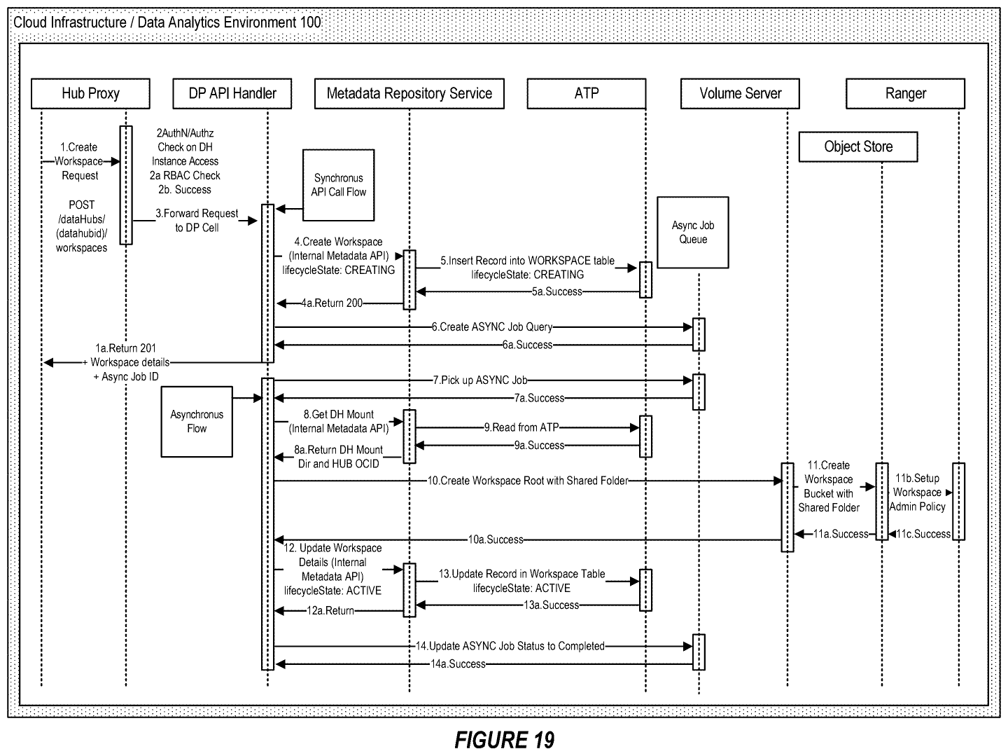

FIG. 19 further illustrates use of an object storage based volume service with support for filesystem access, in accordance with an embodiment.

As illustrated in FIG. 19, in accordance with an embodiment, a workspace can be considered a special volume with special folders and files not belonging any schema or catalog. Files/folder within the workspace can have special RBAC privileges. All workspaces within a hub will be provided with storage under an object storage bucket.

Access Volume from Notebook Using Non-Spark

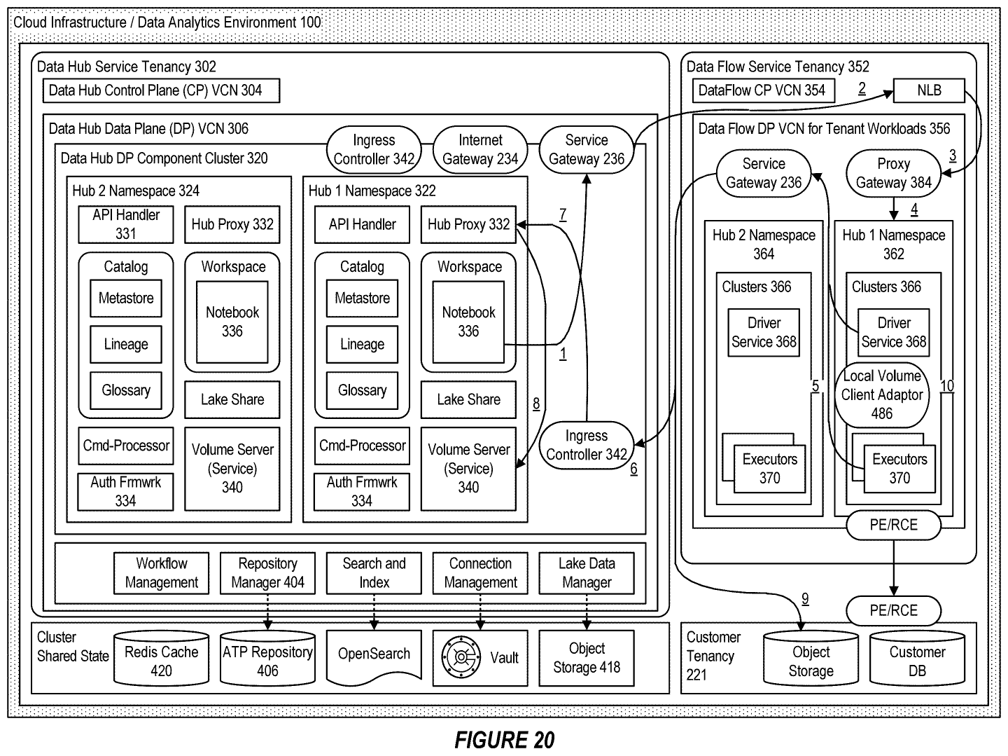

FIG. 20 further illustrates use of an object storage based volume service with support for filesystem access, in accordance with an embodiment.

As illustrated in FIG. 20, in accordance with an embodiment, the system can support a data flow of volume access from notebook execution of a python file API associated AuthN/AuthZ. Instead of using a local volume client adapter with Spark session, a generic FUSE driver is used to provide native local volume access for non-Spark execution (such as Pandas or shell) via an enhanced FUSE driver.

In accordance with an embodiment, the notebook server forwards the request to a cluster data plane (DP) endpoint via a service gateway. A dataflow data plane (DP) load balancer receives the request and forwards the call to a downstream proxy gateway 384, which performs an AuthN/AuthZ check of the whitelisted data hub principal against the principal of the request headers; and forwards the call to the matching driver service 368 pod of the cluster. The driver service pod interprets the execution and detects the path being accessed is a local path mounted via a FUSE driver without using Spark. The call is then sent to the local file system 486. The FUSE driver receives the call, looks up the calling user from a localUserIAM user mapping server provided by the driver service, and forwards the call to the data hub service data plane (DP) load balancer along with the dh-user-principal headers. The ingress controller 342 routes hub instance specific requests based on the data hub instance virtual host address to the hub proxy. The hub proxy intercepts the call and sends the call downstream to the volume server/service, which returns the requested file access info to the FUSE driver, which uses the returned object storage location to read the CSV file.

Access Volume from Cluster Via Notebook Execution with Spark

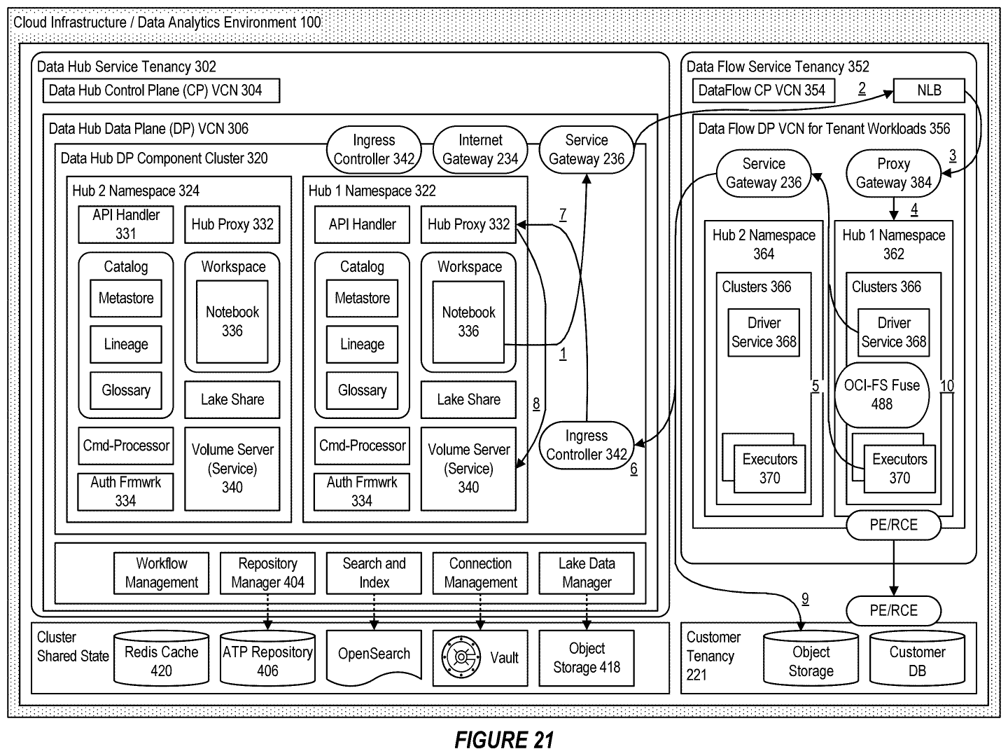

FIG. 21 further illustrates use of an object storage based volume service with support for filesystem access, in accordance with an embodiment.

As illustrated in FIG. 21, in accordance with an embodiment, the system can support a data flow of volume access from notebook execution against a data hub cluster with associated AuthN/AuthZ check.

In accordance with an embodiment, a hub workspace user executes a notebook cell written in Python reading a CSV file mounted to a POSIX path. The notebook server forwards the request to a cluster data plane (DP) endpoint via a service gateway using OKE workload ID based principal representing the hub instance) with IAM. The dataflow data plane (DP) load balancer receives the request and forwards the call to a downstream proxy gateway, which performs an AuthN/AuthZ check, and forwards the call to the matching driver service pod of the cluster. The driver service pod interprets the execution and generates a Spark query plan. During the execution, the Spark driver/executor 370 detects the path being accessed is a local path mounted via a FUSE driver 488. The call is intercepted via a Hadoop Local File System Adapter, which resolves the path and forwards the request to the volume service running in the data hub service data plane (DP) using volume service client with datahubrun resource principal+dh-user-principal headers. The ingress controller routes hub instance specific requests based on the data hub instance virtual host address to the hub proxy. The hub proxy receives the call and checks RBAC/AuthZ based on data asset (prod_catalog.dev_schema.staging_volume), the requested access (READ) and the user's granted permissions. The hub proxy will then send the call downstream to the volume server/service, which returns the requested file access information to the volume client running in a Local File System adapter. A Hadoop Local File System Adapter uses the volume service client to access the mapped object storage location to read the CSV file.

### Delete Volume Flow

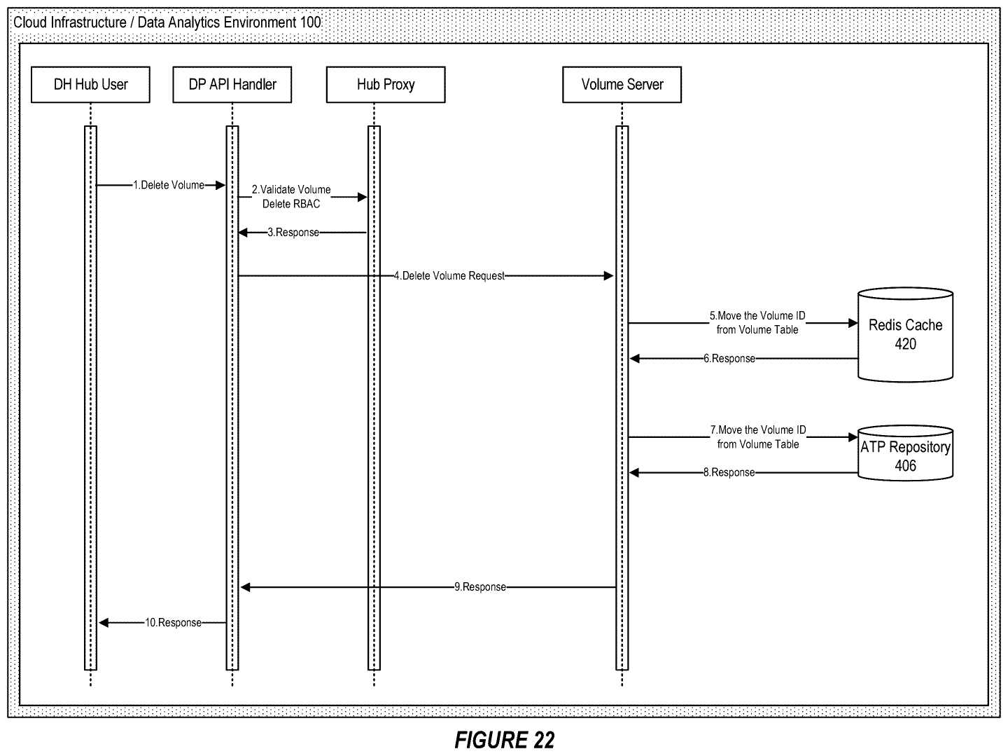

FIG. 22 further illustrates use of an object storage based volume service with support for filesystem access, in accordance with an embodiment.

As illustrated in FIG. 22, in accordance with an embodiment, when a volume is dropped, the volume ID is moved from the volume table to the deletion table. If the dropped volume is a managed volume, the corresponding tables from ATP and Redis are then cleaned up asynchronously and an object lifecycle management policy is set on the corresponding folder for volume under the schema/catalog bucket. If an external volume is dropped, only the policies in RBAC (e.g., Ranger) if any will be cleaned up.

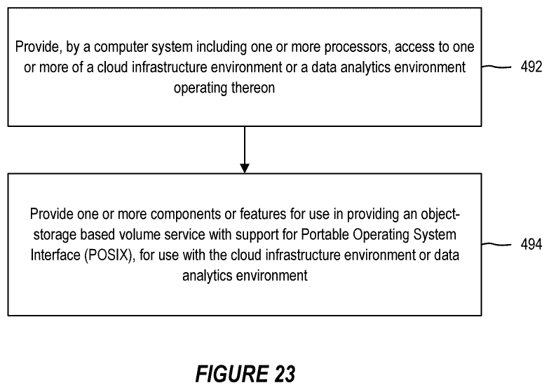

FIG. 23 further illustrates use of an object storage based volume service with support for filesystem access, in accordance with an embodiment.

As illustrated in FIG. 23, in accordance with an embodiment, at 492, a computer system, including one or more processors, provides access to one or more of a cloud infrastructure environment or a data analytics environment operating thereon.

At 494, the system provides one or more components or features for use in providing an object storage based volume service with support for Portable Operating System Interface (POSIX), for use with the cloud infrastructure environment or data analytics environment.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Cloud Infrastructure or Oracle Analytics Cloud; in accordance with various embodiments, the systems and methods described herein can be used with other types of enterprise software applications, cloud environments, cloud services, cloud computing, data analytics, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use with a cloud computing environment to provide an object storage based volume service, comprising:
a computer including one or more processors, that provides access to a cloud computing environment operating thereon; and
wherein the system includes one or more components or features for use in providing support for filesystem access, for storage and use of data within cloud computing environment.

2. The system of claim 1, wherein the filesystem access is provided in accordance with Portable Operating System Interface (POSIX) standards.

3. The system of claim 1, wherein a metadata layer virtualizes a hierarchical namespace from mounted filesystem paths on client machines, wherein Paths to folders or to individual files are mapped to immutable identifiers (IDs) that are stored in the metadata layer.

4. The system of claim 1,
wherein rename operations can be efficiently performed by respectively updating a new name for an immutable ID; and
wherein delete operations can be performed by removing the immutable ID from the path-to-ID mapping.

5. The system of claim 1, wherein the support for filesystem access is provided within or as part of a data hub service for use within the cloud computing environment as part of a cloud infrastructure or data analytics environment.

6. A method for use with a cloud computing environment to provide an object storage based volume service, comprising:
providing, by a computer system including one or more processors, access to a cloud computing environment operating thereon; and
wherein the system includes one or more components or features for use in providing support for filesystem access, for storage and use of data within cloud computing environment.

7. The method of claim 6, wherein the filesystem access is provided in accordance with Portable Operating System Interface (POSIX) standards.

8. The method of claim 6, wherein a metadata layer virtualizes a hierarchical namespace from mounted filesystem paths on client machines, wherein Paths to folders or to individual files are mapped to immutable identifiers (IDs) that are stored in the metadata layer.

9. The method of claim 6, wherein
wherein rename operations can be efficiently performed by respectively updating a new name for an immutable ID; and
wherein delete operations can be performed by removing the immutable ID from the path-to-ID mapping.

10. The method of claim 6, wherein the support for filesystem access is provided within or as part of a data hub service for use within the cloud computing environment as part of a cloud infrastructure or data analytics environment.

11. A non-transitory computer readable storage medium, including instructions stored thereon which when read and executed by one or more computers cause the one or more computers to perform a method comprising:
providing, by a computer system including one or more processors, access to a cloud computing environment operating thereon; and
wherein the system includes one or more components or features for use in providing support for filesystem access, for storage and use of data within cloud computing environment.

12. The non-transitory computer readable storage medium of claim 11, wherein the filesystem access is provided in accordance with Portable Operating System Interface (POSIX) standards.

13. The non-transitory computer readable storage medium of claim 11, wherein a metadata layer virtualizes a hierarchical namespace from mounted filesystem paths on client machines, wherein Paths to folders or to individual files are mapped to immutable identifiers (IDs) that are stored in the metadata layer.

14. The non-transitory computer readable storage medium of claim 11, wherein
wherein rename operations can be efficiently performed by respectively updating a new name for an immutable ID; and
wherein delete operations can be performed by removing the immutable ID from the path-to-ID mapping.

15. The non-transitory computer readable storage medium of claim 11, wherein the support for filesystem access is provided within or as part of a data hub service for use within the cloud computing environment as part of a cloud infrastructure or data analytics environment.
